(19) United States
(12) Patent Application Publication
(10) Pub. No.: US 2013/0122872 A1
(43) Pub. Date: May 16, 2013

(54) APPARATUS AND METHOD FOR PUSH-TO-SHARE FILE DISTRIBUTION WITH PREVIEWS

(71) Applicant: QUALCOMM Incorporated, San Diego, CA (US)

(72) Inventors: Beth Ann Brewer, San Diego, CA (US); Mark Aaron Lindner, Verona, WI (US)

(73) Assignee: QUALCOMM INCORPORATED, San Diego, CA (US)

(21) Appl. No.: 13/734,157

(22) Filed: Jan. 4, 2013

Related U.S. Application Data
(63) Continuation-in-part of application No. 12/358,979, filed on Jan. 23, 2009.
Application No. 12/358,979 is a continuation-in-part of application No. 12/141,493, filed on Jun. 18, 2008.
(60) Provisional application No. 60/945,102, filed on Jun. 20, 2007.

(51) Int. Cl. H04W 4/10

(52) U.S. Cl. CPC H04W 4/10
USPC 455/414.1

(57) ABSTRACT

An apparatus and method provides for transmitting previews of media objects that are shared in a group communication, such as a push-to-talk or push-to-share communication session. Media objects can be stored at a media server and/or an originating communicating device. A plurality of previews for the media object can be selected and/or generated by the originating device and transmitted during a PTT session. The previews can contain metadata, and the previews and metadata can be used by recipients at target mobile devices to determine whether the user wants to download the media object. Different previews for the media object may be selected for different target mobile devices.

This application is a continuation-in-part of prior application Ser. No. 12/358,979, filed Jan. 23, 2009, entitled “SYSTEM AND METHOD FOR PUSH-TO-SHARE FILE DISTRIBUTION WITH PREVIEWS.” This application is also a continuation-in-part of prior application Ser. No. 12/141,493, filed Jun. 18, 2008, entitled “SYSTEM AND METHOD FOR SHARING MEDIA IN A GROUP COMMUNICATION AMONG WIRELESS COMMUNICATION DEVICES,” which claims priority to U.S. Provisional Patent Application No. 60/945,102. All three of these documents are hereby incorporated by reference in their entirety.

### BACKGROUND

The present invention relates to point-to-point or point-to-multipoint wireless communications systems. More specifically, the present invention relates to systems and methods for sharing various forms of media between wireless telecommunication devices.

In wireless telecommunication devices, such as cellular phones, PDAs, mini-laptops, and advanced pagers, the devices typically communicate over long distances by bridging telephone calls through existing cellular telephone networks and passing data packets across the network. These wireless devices often have limited or significant data processing and computing capability, and can accordingly send and receive software programs, in addition to voice, across the telephone network.

There exists a wireless telecommunication service that provides a quick one-to-one or one-to-many communication that is generically referred to as “Push-To-Talk” (PTT) capability. The specific PTT group of recipient devices for the communicating wireless device is commonly set up by the carrier. A PTT communication connection is typically initiated by a single button-push on the wireless device that activates a half-duplex link between the speaker and each member device of the group and once the button is released, the device can receive incoming PTT transmissions. Existing PTT systems have advantages over traditional cellular systems because they have faster call setup times, e.g., setup times ideally in the range of 1 second as opposed to cellular voice channels that can take more than 5 seconds to establish. In some arrangements, the PTT speaker will have the “floor” where no other group member can speak while the speaker is speaking. Once the speaker releases the PTT button, any other individual member of the group can engage their PTT button and they will have the floor. Generally speaking, the PTT system uses standard voice-over internet protocol (VoIP) technologies. Voice information is sent in digital form over IP-based data networks. In PTT scenarios, instead of using the standard cellular infrastructure a call is formed by combining separate point-to-point connections between each. IP endpoint at a server. Initiating the PTT system generates a call to the target device. The call originator's voice can be sent through the carrier's network to the target handset.

In existing PTT systems, member devices will only communicate voice data between the devices during a communication session. It is difficult to include other data in the group communication because of the size of the data and the device resources necessary to handle non-voice data. A mobile device that therefore desires to send non-voice data, such as media objects, must typically do so through specific data channels established between the device and a wireless communication network, and not the PTT channels.

Accordingly, it would be advantageous to provide a system and method for a mobile device to send a plurality of previews of a media object to others during a PTT communication session that provides information for each recipient to decide whether or not to download the media object. It is thus to such an apparatus and method that the present invention is primarily directed.

### SUMMARY

Briefly described, the present invention is for an apparatus and method for transmitting previews for media objects that are shared in a group communication, such as a push-to-talk or push-to-share communication session. Media objects can be stored at a media server and/or an originating communicating device. A plurality of previews for the media object can be generated by the originating device and transmitted during a PTT session. The previews can contain metadata, and the previews and metadata can be used by recipients at their respective target mobile devices to determine whether the user wants to download the media object. In an embodiment, different previews for the media object may be selected for and transmitted to different target mobile devices.

The present invention is therefore advantageous as it provides an apparatus and method that can be employed on a mobile device to send a plurality of previews of a media object to other devices during a PTT or other group communication session. This can allow a potential receiving wireless device to choose to opt out of receiving the media, or specifically prepare for the receipt of the media object. The plurality of previews of the same media object may differ from one another. In an embodiment, a plurality of previews of the same media object may be sent to a plurality of target mobile devices, wherein of the plurality of mobile devices receives a singular preview, but the preview received by one target device may differ from the preview received by another mobile device.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 illustrates an exemplary operational environment for practicing aspects of the present disclosure.

FIG. 2 illustrates an exemplary wireless network in a common cellular telecommunication configuration.

FIG. 3A, illustrates an exemplary mobile computer platform and components that can be a mobile device.

FIG. 3B, illustrates exemplary software layers resident on the computer platform of FIG. 3A.

FIG. 4 illustrates an exemplary operational procedure for generating and transmitting a plurality of previews for a media object to a target device.

FIG. 5 illustrates an exemplary operational procedure for receiving a preview for a media object.

FIG. 6 illustrates an exemplary operational procedure for facilitating the transfer of a preview for a media object between a sender mobile device and receiver mobile device.

FIG. 7 illustrates an exemplary call flow for establishing a push-to-talk session.

FIG. 8 illustrates an exemplary call flow diagram for one embodiment of a method of transmitting a preview for a media object during a floor that is shared between talking devices and sending previews for media objects.

FIG. 9 illustrates an exemplary call flow diagram of one embodiment of a method of transmitting a preview for a media object on a different floor from the PTT client.

### DETAILED DESCRIPTION

In this disclosure, the terms ‘communication device,’ ‘wireless device,’ ‘wireless communications device,’ ‘PTT communication device,’ ‘handheld device,’ ‘mobile device,’ and ‘handset’ are used interchangeably. The terms ‘call’ and ‘communication’ are also used interchangeably. The term ‘exemplary’ means that the disclosed element or embodiment is only an example, and does not indicate any preference of user. The term ‘group communication’ encompasses a one-to-one or one-to-many, half-duplex communication, or full-duplex communication operating in half-duplex mode. The term ‘floor’ is as understood in the PTT or half-duplex group communication art, i.e. the device that has the ability to send voice/data on a forward link while other devices of the group can only receive voice/data. Further, like numerals refer to like elements throughout the several drawings, and the articles “a” and “the” include plural references, unless otherwise specified in the description.

The term ‘circuitry’ used through the disclosure can include specialized computer circuits that embody logic operable to perform function(s). In other instances, the term ‘circuitry’ can include a general purpose processing unit that can be configured by software instructions that embody logic operable to perform function(s). In this example, an implementer may write source code embodying logic that can be compiled into machine readable code. The compiled code can then be processed by the general purpose processing unit thereby transforming the general purpose processing unit into a special purpose processor. One skilled in the art can appreciate that the state of the art has evolved to a point where there is little difference between hardware, software, and a combination of hardware/software, and the selection of hardware versus software is a design choice left to an implementer. More specifically, one of skill in the art can appreciate that a software process can be transformed into an equivalent hardware circuit, and a hardware circuit can itself be transformed into an equivalent software process.

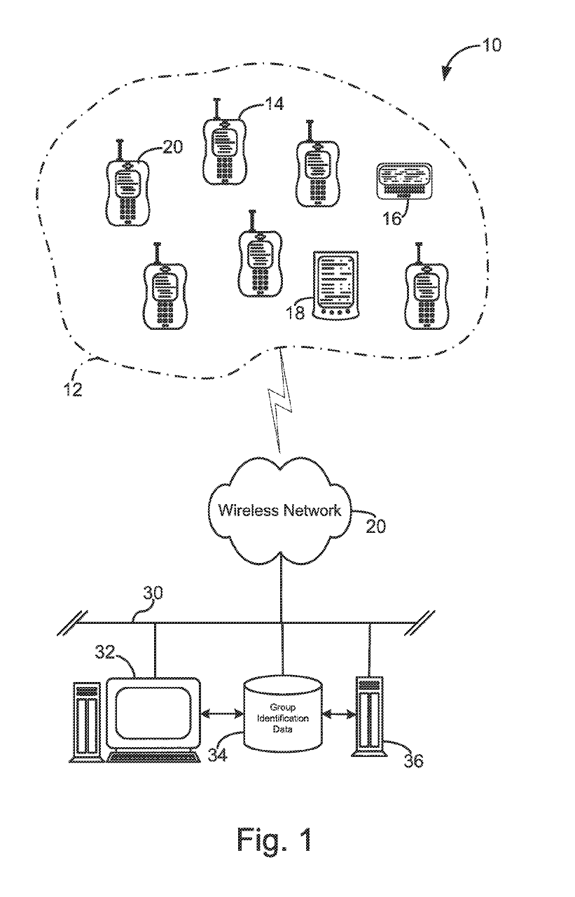

FIG. 1 illustrates an example embodiment of a system 10 for sharing previews of media objects and media objects among one or more wireless telecommunication devices in a PTT group 12, such as the wireless telephone 14, smart pager 16 and personal digital assistant (PDA) 18, with other wireless telecommunication devices across a wireless network 22. In the system 10, each wireless telecommunication device 14,16,18 can be capable of selectively directly communicating across the wireless communication network 22 with a target set of one or more other wireless telecommunication devices of the plurality. For example, the target set for mobile telephone 14 can be all devices in the communication group 12 or a subset thereof, such as pager 16 and PDA 18.

In this embodiment, the wireless telecommunication device (such as mobile telephone 14) can send a flag to at least the group communication computer device, shown here as server 32, which is present on a server-side LAN 30 across the wireless network 22. The flag in this example can be used by the server to determine that the wireless device is present, i.e. accessible, on the wireless network 22. The group communication computer device 32 can share this information with a set of target wireless telecommunication devices designated by the first wireless telecommunication device or it can also share this with other computer devices resident on the server-side LAN 30 or accessible across the wireless network 22. The group communication computer device 32 can have an attached or accessible database 34 to store the group identification data for the wireless devices. A media server 36 can additionally include circuitry for a file management server that can be present on the server-side LAN 30. It should be appreciated that the number of computer components resident on server-side LAN 30, or across the wireless network 22, or Internet generally, are not limited.

The group communication, such as a PTT communication, can be established through a half-duplex channel between the communicating wireless telecommunication device 14,16,18 and the one or more other wireless telecommunication devices of the target set. Also, the group communication server 32 can attempt to bridge the requested direct communication with the target set if at least one of the wireless telecommunication devices of the target set have informed the group communication server 32 of their presence on the wireless network 22.

The group communication server 32 can also inform the wireless telecommunication device 14,16,18 of the inability to bridge a direct communication to the target set 12 upon none of the wireless telecommunication devices (or at least one) of the target set not having informed the group communication server 32 of their presence on the wireless network 22. Further, while the group communication server 32 is shown here as having the attached media server 34 of group identification data, the group communication computer device 32 can have group identity data resident thereupon, and perform all storage functions described herein.

In overview, the system 10 can include at least one wireless communication device, such as mobile telephone 14, that can be a member of a communication group 12 of wireless communication devices. The wireless communication devices in this example can be configured to communicate with each other or communicate as a group across a wireless communication network 22. In addition, at least one of the wireless communication devices can be configured to selectively send previews of media objects to other members of the communication group 12. At least one group communication server 32 is configured to store information on communication groups 12 on the wireless communication network 22, the information including the identity of the specific member wireless communication devices of one or more communication groups. The group communication server 32 is further configured to selectively receive previews for media objects from a sending wireless communication device, such as mobile telephone 14, of a communication group 12 and download the media objects at a later time.

The system 10 can further include a media server 36 in communication with the group communication server 32, with the group communication server 32 configured to send media objects to the media server 36, as is further described herein. The media server 36 can be configured to receive the media objects from the wireless communication device (such as mobile phone 14) and selectively permit members of the communication group 12 for which the preview was sent to access the stored media object across the wireless communication network 22.

For example, in an embodiment of the present disclosure the media object can include, but is not limited to, pictures in JPEG, TIF, and the like, audio files such as MP3, MP4, WAV, and the like, documents, schedules, calendar events, emails, spreadsheets, drawings (such as Visio drawings or other CAD/CAM drawings) and/or presentations. The media objects can additionally include streaming media, such as a multimedia application (Powerpoint, MOV file, and the like). Also, the media objects could be half-duplex video conferencing among members of the communication group wherein the picture of the speaker is broadcast to the other group members in substantial real-time, or in delay.

The size of the media object files can be very large, and because of the potential delay of sending the media, or inability of the receiving wireless communication device to handle the sent media, the system 10 can use a media server 36 (or file management server) to store the media objects such that target members of the communication group 12 can selectively access the stored media without interrupting other PTT communications. The media server 36 can be configured to send previews of media objects to each of the member wireless devices of the communication group 12 upon establishing a communication link therewith. Alternatively, in one embodiment, if the media objects are stored at the media server 36, the media server 36 can be configured to send a hyperlink to the originating device or the other member wireless communication devices of the communication group 12. The hyperlink in this example can provide a link to the stored group-directed media at the media server 36. Upon receipt of previews for the media objects by at least one of the member wireless devices of the communication group 12, the group communication server 32 can send an acknowledgement indicating to the wireless communication device 14,16,18 that at least one member wireless communication device of the communication group 12 received the media object.

The wireless communication device 14,16,18 can send communication group identification data to the group communication server 32 at the time of requesting the media object to be sent, e.g. a target list, and thus, the media server 36 can be configured to send or store the media object to or for the member wireless communication devices identified in the communication group identification data based upon a variety of criteria as is further discussed herein. Alternately, prior to the wireless communication device sending media objects, the wireless communication device 14,16,18 can request member data for a communication group 12 from the group communication computer device 32, and the group communication server 32 can send one or more addresses or communication group addresses to the wireless communication device 14,16,18. In one embodiment, the communication group computer device 32 can filter the potential communication groups available based upon their member devices' capability to received media objects.

As is further described herein, the wireless communication device 14,16,18 can be engaged in a group communication with the member wireless communication devices of the communication group 12, and send media objects during the group communication in the same communication session, or independently therefrom. Alternately, the media objects can be sent independently of the group-communication session, with or without an alert to the target devices indicating that the media was sent.

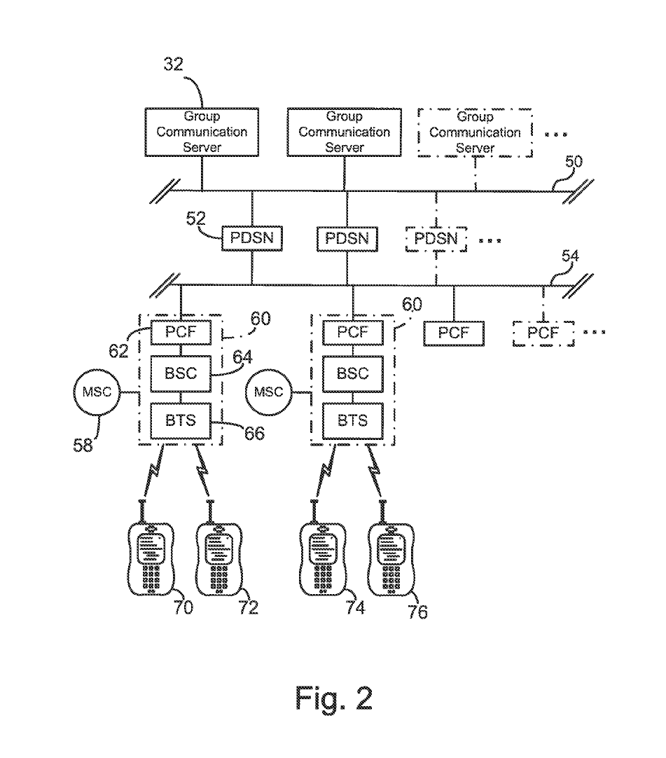

Referring now to FIG. 2, it illustrates an example wireless network in a common cellular telecommunication configuration. The wireless network in this example can include a series of group communication servers 32 that control communications between the wireless communication devices of set group members (devices 70,72,74,76) in a PTT system. The wireless network is merely exemplary and can include any system whereby remote modules communicate over-the-air between and among each other and/or between and among components of a wireless network 22, including, without limitation, wireless network carriers and/or servers. A series of group communication servers 32 are connected to a group communication server LAN 50. Wireless telephones can request packet data sessions from the group communication server(s) 32 using a data service option.

Continuing with the description of FIG. 2, the group communication server(s) 32 in this example can be connected to a wireless service provider's packet data service node (PDSN) such as PDSN 52, shown here resident on a carrier network 54. Each PDSN 52 can interface with a base station controller 64 of a base station 60 through a packet control function (PCF) 62. The PCF 62 can be located in the base station 60. The carrier network 54 can control messages (generally in the form of data packets) sent to a messaging service controller (“MSC”) 58. The carrier network 54 in this example can communicate with the MSC 58 by a network, the Internet and/or POTS (“plain ordinary telephone system”). Typically, the network or Internet connection between the carrier network 54 and the MSC 58 transfers data, and the POTS transfers voice information. The MSC 58 can be connected to one or more base stations 60. In a similar manner to the carrier network, the MSC 58 is typically connected to the branch-to-source (BTS) 66 by both the network and/or Internet for data transfer and POTS for voice information. The BTS 66 ultimately broadcasts and receives messages wirelessly to and from the wireless devices, such as cellular telephones 70,72,74,76, by short messaging service (“SMS”), or other over-the-air methods known in the art. It should also be noted that carrier boundaries and/or PTT operator network boundaries do not inhibit or prohibit the sharing of data as described herein.

Cellular telephones and mobile telecommunication devices, such as wireless telephone 14, are being manufactured with increased computing capabilities and are becoming tantamount to personal computers and hand-held PDAs. These “smart” cellular telephones allow software developers to create software applications that are downloadable and executable on the processor of the wireless device. The wireless device, such as cellular telephone 14, can download many types of applications, such as web pages, applets, MIDlets, games and data. In wireless devices that have designated a communication group 12 (such as depicted by FIG. 1), the wireless communication device can directly connect with the other member of the set and engage in voice and data communication. However, such direct communications will occur through, or at the control of, the group communication computer device 32. All data packets of the devices do not necessarily have to travel through the communication server 32 itself, but the communication server 32 must be able to ultimately control the communication because it will typically be the only server-side 30 component that is aware of and/or can retrieve the identity of the members of the communication group, or direct the identity of the members of the communication group 12 to another computer device.

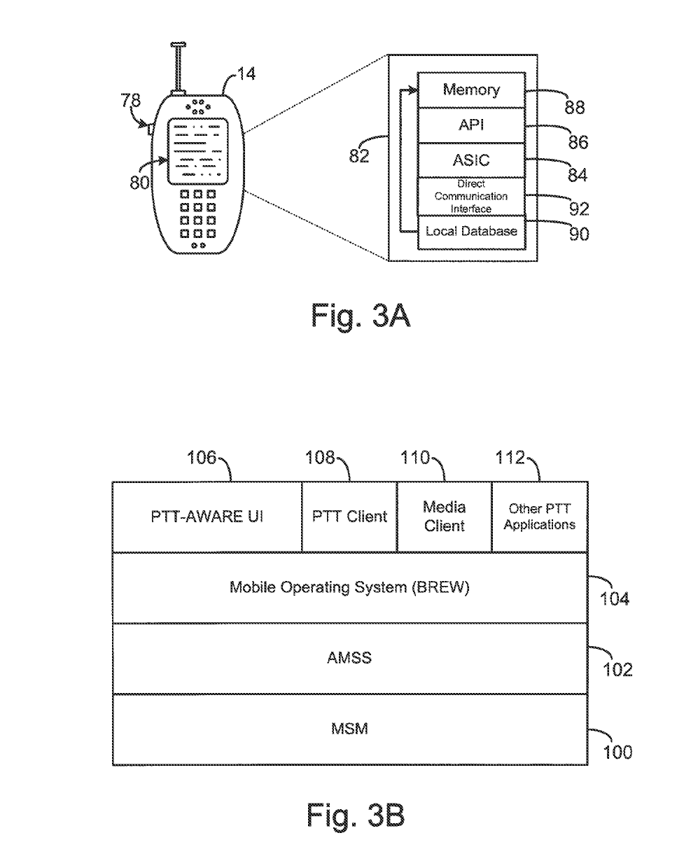

Referring now to FIG. 3, it illustrates an example wireless telecommunication device that can be a mobile telephone 14 with a PTT button 78 that opens the direct communication to a target device. The wireless device 14 is also shown as having a graphics display 80. The wireless device 14 can include a computer platform 82 that can handle voice and data packets, and receive and execute software applications transmitted across the wireless network 22. The computer platform 82 includes, among other components, an application-specific integrated circuit (“ASIC”) 84, or other processor, microprocessor, logic circuit, programmable gate array, or other data processing device. The ASIC 84 is installed at the time of manufacture of the wireless device and is not normally upgradeable. The ASIC 84 or other processor executes an application programming interface (“API”) layer 86, which includes the resident application environment, and can include the operating system loaded on the ASIC 84. The resident application environment interfaces with any resident programs in the memory 88 of the wireless device. An example of a resident application environment is the “binary runtime environment for wireless” (BREW) software developed by QUALCOMM® for wireless device platforms.

As shown here, the wireless device 14 can be a mobile telephone, with a graphics display 80, but can also be any wireless device with a computer platform 82 as known in the art, such as a personal digital assistant (PDA), a pager with a graphics display 80, or even a separate computer platform 82 that has a wireless communication portal, and may otherwise have a wired connection to a network or the Internet. Further, the memory 88 can be comprised of read-only or random-access memory (RAM and ROM), EPROM, EEPROM, flash cards, or any memory common to computer platforms. The computer platform 82 can also include a local database 90 for storage of software applications not actively used in memory 88. The local database 90 is typically comprised of one or more flash memory cells, but can be any secondary or tertiary storage device as known in the art, such as magnetic media, EPROM, EEPROM, optical media, tape, or soft or hard disk. The graphics display 80 can present not only information about the ongoing group call, but also the information about the media object in order to generate a preview as is more fully described herein.

In this embodiment the computer platform 82 can also include a direct communication interface 92 that can open a direct communication channel. The direct communication interface 92 can also be part of the standard communication interface for the wireless device which ordinarily carries the voice and data transmitted to and from the wireless device. The direct communication interface 92 typically is comprised of hardware as is known in the art.

Continuing with the description of FIGS. 3A-3B, additionally depicted is a diagram of one embodiment of the software layers of the group application client that can include, but is not limited to, PTT functionality and media object functionality. In this embodiment, the computer platform 82 in the mobile device environment can include a series of software “layers” developed on top of the Mobile Station Modem (MSM) 100 and the Advanced Mobile Subscriber Software (AMSS) 102, developed by QUALCOMM®. In this example the underlying MSM chipset can implement the software protocol stack for the entire suite of CDMA communication technologies that include CDMA20001x and CDMA2000 1xEV-DO. In this example the AMSS can be configured to support a mobile operating system layer 104, which in this embodiment is BREW®, also developed by QUALCOMM®. The mobile operating system layer 104 can provide an application programming interface for chip or device-specific operations, while providing an isolation layer that eliminates direct contact to the AMSS 102 and any OEM software on the computer platform. The mobile operating system layer 104 can enable application development that uses mobile device features without having to rewrite the application each time a new release of the device-specific software is released.

In this example the mobile operating system 104 can include a PTT client 108 that is configured to offer access to PTT services through an external interface, here shown at a PTT-aware UI 106. The PTT Client 108 can include all the functions required to enable mobile operating system 104 applications, such as the Media Client 110. In this embodiment, the PTT Client 108 can maintain access to PTT services, responds to communication requests, process all PTT-aware mobile operating system applications requests for PTT services, process all outgoing PTT requests, collect and package vocoder packets for originating PTT talk spurts, and parses packets of vocoder data for terminated PTT talk spurts.

The media client 110 in this example can be a mobile operating system-based application that extends PTT services for access to media types other than the traditional half duplex voice communications (VoIP-PTT media). The media client 110 can provide access to media services through an external interface such as a media aware API that is an application that may be developed entirely as a mobile operating system-based application or used in combination with an AMSS 102 interface. The group media aware UI can respond to user requests for media services by invoking the appropriate APIs, such as those from other resident PTT and group media applications 112. The media client 110 can service the request from the user and inform the user the result of any group-directed media request. The media client 110 can additionally be configured to handle incoming notifications that indicate there is media object to download from the file management server (data store 36). For example, the media client 110 can be configured in one embodiment to download media objects immediately or in other embodiments the media client 110 can be configured to download the media object at a predetermined time period, e.g., at 10:00 pm daily, or it can be configured to prompt the user via the PTT UI 106 to determine whether and/or when to download the file.

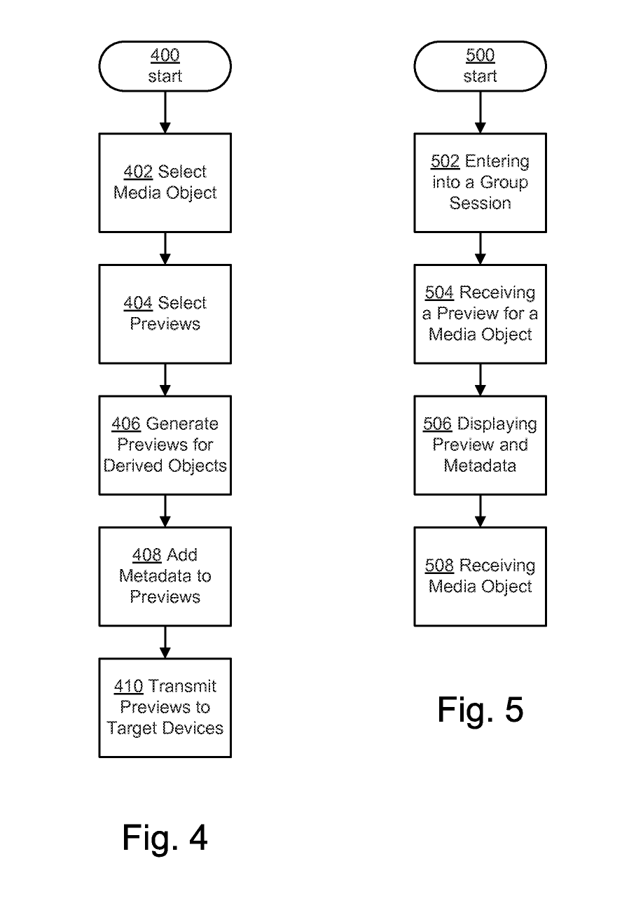

Referring now to FIG. 4, it illustrates an example operational procedure for generating and transmitting a plurality of previews for a media object to a plurality of target mobile devices 20 during a push-to-talk chat session. In this example embodiment, operation 400 begins the operational procedure and operation 402 shows selecting an option to transmit a plurality of previews for a media object from a user interface 80 of device 14. When the user selects such an option the circuitry of the device 14 can be configured by software of the media client 110 to allow a user to select a media object from which a preview or a plurality of previews may be generated. A preview in example embodiments of the present disclosure can generally be anything that provides enough information for the recipient to allow him or her to make an informed decision as to whether they want to download the media object. Once the circuitry of the device is configured by the media client 110 a user can select a media object to share with one or more target devices that could be, for example, members of a group 12 such as device 20.

Media objects in example embodiments of the present disclosure can include, but are not limited to, documents, audio files, digital images, video clips, or any other type of digital media. In example embodiments the media objects can be stored in, for example, local database 90 and/or media server 36 of FIG. 1. For example, in embodiments of the present disclosure a user can obtain an account with a service provider that provides access to online storage such as media server 36. The user can create an account and upload media objects to the media server 36 from time to time. The media server 36 can in this example generate a link, e.g., a hyperlink, to the media object and transmit it back to the mobile device 14. The circuitry of device 14 can be configured in this example embodiment to allow the user to scroll through the media objects and see which ones have been uploaded to the media server 36 and which ones are stored in the local database 90.

Continuing with the description of FIG. 4, at operation 404, a preview for a media object can be selected. For example, circuitry of device 14 can be configured by, for example, the media client 110 to bring up preview selection options. In example embodiments the menu can include generating options to compress the media object to form a preview, clip the media object to form a preview, modify the media object to form a preview, and/or select an icon or record audio or video to act as a preview. This list of preview selection/generating options is not exhaustive, and options that allow a user to select or generate a plurality of previews of the selected media object are contemplated by the present disclosure.

Previews may generally take one of two basic forms: generated objects derived from the media object; and independent objects not derived from the media object. The previews, and any associated metadata, may allow a user on a target device to evaluate whether or not to download the media object from the media server. Such previews may inform the user both as to reasons why the user may desire to download the media object (i.e., encouraging download) and why the user may want to avoid downloading the media object (i.e., discouraging download).

Previews may be derived from the media object and may include, but are not limited to, compressed forms of the media object, reduced size forms of the media object, clipped forms of the media object, cropped forms of the media object, converted forms of the media object, downsampled forms of the media object, and modified forms of the media object. For example, when the media object is a movie file, the preview may comprise a short clip from the movie, a reduced resolution or compressed or downsampled form of the movie, a cropped portion of the movie, a screenshot (image) from the movie, an audio clip from the movie, and combinations thereof. When the media object is a document, the preview may comprise single page from a multipage document, a reduced resolution or compressed or downsampled form of the document or portion thereof, a cropped portion of a page from the document, etc. When the media object is a music file (i.e., song), the preview may comprise a short audio clip from the song, a compressed or downsampled form of the song, a image of the album cover art associated with the song, and combinations thereof. In a preferred embodiment, these previews may require less bandwidth or resources, and thus may be capable of being transmitted over the group communication channel. These types of previews derived from the media object are what most users think of as “previews.”

However, previews in accordance with disclosed embodiments may also take the form of independent objects not derived from the media object. Such independent objects may include icons, such as emoticons, generic images, or trademarked images, as well as independently created images, audio, or movies. For example, when the media object is a movie file, the preview may comprise a “thumbs up” emoticon, an MPAA rating icon, a Disney® logo, a self-shot of the sender (such as with an expression reflecting whether they like the media object), an audio file describing the media object or why the recipient may want to download or avoid downloading the media object, and combinations thereof. When the media object is a document, the preview may comprise a “thumbs down” emoticon, a logo of the organization responsible for the document (e.g., law firm logo), an generic icon with a pen indicating a need to sign the document, a generic document icon, a self-shot of the sender (such as with an expression reflecting whether they like the document), an audio file describing the document or why the recipient should want to download or avoid downloading the document, and combinations thereof. When the media object is a music file (i.e., song), the preview may comprise a “smiley face” emoticon, a generic music icon, a PMRC parental advisory icon, a self-shot of the sender (such as with an expression reflecting whether they like the song), an audio file describing the song or why the recipient may want to download or avoid downloading the song, and combinations thereof. In a preferred embodiment, these independent previews may also require less bandwidth or resources, and thus may be capable of being transmitted over the group communication channel.

In an embodiment of the present disclosure an option to compress the media object to form a preview can be rendered on the display of the device 14 and selected by the user. In this example a compressed copy of the media object can act as a preview for the media object. For example, a media object in an embodiment can be a digital photo having a certain set of pixels. A user may select a compression option and the resolution of the digital picture can be reduced, e.g., it can be modified to contain fewer pixels, thereby creating a preview of the picture that can fit within the bandwidth requirements available in a push-to-talk communication channel.

In another example embodiment the menu can include an option to select a portion of the media object as a preview. In this example embodiment the media object can include a document, presentation, spreadsheet, a picture, etc. The media client 110 can be configured to allow the user to draw a bounding box over a portion of the media object, and/or select a paragraph, page, or slide, and use the selected portion as a preview. In other example embodiments, such as a video or audio media object, the media client 110 can be configured to allow the user to select a time range to act as a preview, e.g., a user may select 30 seconds of a song or 10 seconds of a video to act as a preview.

The media client 110 in this example, and other exemplary embodiments, can include a menu option for selecting an icon to represent the media object. For example, in one embodiment emoticons such as smiley faces can be used to represent the media object, or in other embodiments, small generic images such as images of flowers, or sporting events, can be stored in memory of the device 14. When the user selects a media object they can scroll through a list of images that can be used as a preview and select one. For example, if the media object is a movie, the user may select an image of a person watching a movie to represent the media object.

For example, trademarked icons can be provided by companies that can be used as previews in example embodiments. These trademarked icons can be used as a preview for the media object and they can additionally act as source identifiers for the media objects. For example, a user may want to send a preview for a patent application drafted by a patent attorney from a specific law firm. The user may select the trademarked icon that the law firm places on firm letterhead to act as a preview for the patent application. In this example the preview could indicate that the media object came from the law firm. Another example may include a video of a baseball player hitting a home run. In this example, the user may select an icon such as the team logo for the player.

The media client 110 in this example, and other exemplary embodiments, may also include a menu option for recording an audio or video clip describing the media object. For example, in one embodiment a user may be presented the option of recording an audio file describing the selected media object or why the intended recipient may want to download or avoid downloading the media object, which can be can be stored in memory of the device 14 for use as a preview.

Referring to operation 406, after the user scrolls through the options of previews to generate, he or she can select a plurality of preview options and previews may be selected/generated, however in other example embodiments a plurality of previews of different type may be generated and the user may select the one he or she thinks coveys the ‘right’ amount of information for an intended user of a target device. In this manner, different previews of the same media object may be transmitted to different target devices. The mobile device 14 may be configured to display a menu that may allow the user to select a plurality of different preview options and view and/or hear them in order to determine which one he or she want to select as the preview. In a specific example, a user may decide to send a digital image to a friend and select an option to compress the image, e.g., remove pixels, an option to crop the image, an option to covert the image to black and white, etc. The user could scroll through all three choices and decide which one they want to use as the preview and select the desired choice to be sent to the friend's target device.

Continuing with the description of FIG. 4, example operation 408 shows that in an example embodiment metadata may be added to each of the generated previews, e.g., either in a header of the previews and/or a body of a message that contains the previews. In an embodiment the metadata can be used to provide additional information to the intended user of each target device 20. The metadata in this example may include information that describes the media object, or other information that describes information related to the media object. The metadata may be obtained and generated by a variety of metadata sources such as the user, the device 14, the media server 36 and the target device 20. Each metadata source may add metadata to the preview in order to provide the user of the target 20 with enough information to determine whether they want to download the media object. For example, a user may generate metadata for a preview of a media object. The device 14 in this example can include a keypad and/or a keyboard operable to receive text. The user may access a menu from the media client 110 and add text to the media object that may, for example, describe the media object. In another embodiment the menu can include predefined text options that can be selected by the user and added to the preview.

In another example embodiment the user can select an option to have their account charged if an intended user of a target device 20 downloads the media object. For example, a service provider may charge a fee for downloading media objects, but may allow users to receive previews for free. In this example, a user that wants to share media objects with target mobile devices 20 and can select an option on the media client indicating that they will pay for the downloads. In this example, information indicative of the choice can be stored along with other metadata in a header of the previews and/or in a body of a message that includes the media object.

The circuitry of the device 14 can be configured by, for example, the media client 110 to provide information to the user in order to help them generate previews. For example, in an embodiment the PTT client 108 can identify a size limit, e.g., a maximum transmission unit, for previews and, while the user is selecting a preview, information that identifies the current size of the preview can be overlaid on display 80. For example, a user may want to crop an image as a preview. In this example the media client 110 can be configured to receive information from the PTT client 108 that identifies a maximum size limit for sending data over a push-to-talk link. This information can be overlaid on a preview generation screen along with the current size of the preview. The user interface can generate a bounding box over the image that can be reduced in size by the user. As the user reduces the size of the bounding box the media client 110 can be configured to calculate the current size of the information within the bounding box. In this example the user can use the information to determine how much they have to crop the image. A similar technique can be applied to music, video, and documents. More specifically, the media client 110 can be configured to allow a user to select a portion of a video clip and information can be displayed on the screen that indicates whether the clip is too large. In the document example the user could generate a bounding box over a portion of the document, or the user could select a certain range of text and information on the display can provide information indicating whether the portion of the document is too large.

In another example embodiment, mobile device 14 can include circuitry configured to generate and add metadata to the previews. For example, in an example embodiment the device 14 can include and/or obtain information such as the file extension for the media object, a link to the media object, e.g., a file path to the object on the device and a device identifier such as an identifier used by the network, the file size for the media object, the date it was modified and/or created, the identity of the entity that created the media object, e.g., name of the company or the user that made the media object, copyright information for the media object, etc. In an example embodiment this information can be merged with information obtained from the media server 36 such as a hyperlink to the media object, the file size of the media object stored on the media server 36, price associated with downloading the media object from the server, etc. For example, in an embodiment the media server 36 may store the media object and determine a price for downloading the media object based on the object's size. This information can be transmitted to the device 14 and added to the previews. The previews can be sent to the target devices 20 and the information can be displayed. In this example the target devices 20 can obtain pricing information prior to attempting to download the media object from the media server 36.

In the same, as well as other embodiments, the media server 36 can generate additional metadata that can be sent to the device 14 and sent along with the previews to the targets 20, or can be sent to the targets 20 in response to a request from the targets 20. In this example embodiment the metadata can include information that identifies conversion options for the media object's file format. The media server 36 can include a database management program and circuitry, e.g., a processor configured by a program, for discovering the file extension of the stored media objects. For example in an embodiment a media object can have a specific file type such as .mov, .jpeg, .tiff, .pdf, .ppt, .doc, .mp3, .mpeg, etc. In an example embodiment of the present disclosure when the media object is stored by the communications server 32, circuitry of the media server 36 can be configured to determine the file extension is for the media object and determine whether the media object can be converted from one file type to another. This information in an embodiment can be sent back to the mobile device 14, for example in a message that acknowledges the success of the storage operation. The information can be stored in the header of the media object along with other metadata. In a specific example, a media object can be a video with a file extension of .mov. In this example, when the video is uploaded to the media server 36, circuitry of the server can be configured to determine whether the file can be converted to another format. A table stored in memory can be accessed and the circuitry can search for .mov. In this example the media server 36 may include circuitry for converting the .mov file to an .mpeg, .divx, mpg, or another movie file type. The conversion circuitry in this example can be configured to determine that it can convert the video into different formats and transmit the list of conversion options to the mobile device 14 where the information can be stored in the header of the media object or a body of a message that includes the media object. This information can then be sent to the target 20 in the preview and a user of the preview can be presented with information that indicates that if they want a copy of the media object it can be downloaded in mpg format instead of .mov format.

Referring now to operation 410, once a plurality of previews are generated for the media object, they may be transmitted to the plurality of target devices 20 over a push-to-talk communication channel. For example, once the user has decided to send the generated previews for a media object to a plurality of target devices 20 they can establish a push-to-talk session with the target devices 20 and send the previews. In the instance that user is already engaged in a push-to-talk session, the user can send the previews for the media object to the target devices 20 during the session when they have the floor.

Referring now to FIG. 5, it illustrates an operational procedure related to receiving media objects from a device 14. Operation 500 begins the operational procedure and operation 502 shows that the target device 20 can enter a push-to-talk communication session with a device 14. For example, a user of a target device 20 can receive a signal from the device 14 (via one or more servers of a data network) indicating that the user wants to enter into a PTT session with them. In one embodiment the user of the target device 20 can accept the communication and either start a conversation with the user of the device 14 and/or receive a preview for a media object (depending on whether the user of device 14 sent a preview prior to entering into a conversation.) As illustrated by operation 504, the target device 20 can receive a preview that can provide enough information to allow the user of the target device 20 to make an informed decision as to whether they want to download the media object. Similar to that described above, the preview can include, but is not limited to, a compressed version of the media object, a portion of the media object, and/or an icon, etc.

Once the preview is received the target device 20, in an embodiment, metadata can be generated from any metadata associated with the preview. For example, the media client 110-T of the target 20 can generate metadata from the metadata received from the originating device 14, media server 36, and the user of device 14. For example, the target device 20 can include information that identifies a data plan that the user has subscribed to. The data plan can in this example include information that indicates whether the user has subscribed to a plan that allows unlimited PTT media object downloads. When the target device 20 receives the preview and it is displayed information that indicates how much it will cost to download can be presented to the user. In addition, in one embodiment the target device 20 can include information that indicates how much storage is available to store media objects. Information that defines the size of the media object and the available storage can be used to calculate how much remaining storage will be available for the target device 20 if the media object is downloaded. In the same, or other embodiments, the target device 20 can use information that indicates how large the media object is and the available bandwidth to generate an estimated amount of time it would take to download the object. For example, when the preview is received the target device 20 can use information that identifies the location of the media server 36 to ping it to determine latency. The latency can then be used to determine how long it would take to download the media object and this information can be displayed along side the other metadata.

Once the preview and metadata are received they can be displayed on a screen of the target device 20 as shown by operation 506. The preview can be displayed and the metadata can be organized and displayed on the user interface 80 of target device 20. For example, the metadata can be organized into different tabs that can be selected by the user such as ‘conversion info,’ ‘downloading info,’ and/or ‘media object info.’ Each tab in this example embodiment can include metadata from the different sources, for example, the media object info could include information generated by the device 14 such as information about size, author name, data modified, and text generated by the user of device 14 such as a subject line to provide context for the preview.

If the user of target device 20 decides to download media object then a link embedded in the preview or a body of a message that includes the preview can be selected and the media object can be downloaded as shown by operation 508. For example in an embodiment the link can be a hyperlink to the media object stored on the media server 36 or in another example it can be a link to the media object stored on the device 14. In one instance the media server 36 may store a copy of the media object and transmit a hyperlink to the device 14. When device 14 sends a preview to target device 20 it can include the hyperlink. In this example the user of the target device 20 can “click” (or “select”) the hyperlink and download process can be started. In another embodiment the link could be associated with device 14. For example media object may not be stored on media server 36 when the preview is transmitted to the target. In this example the link could include information such as a device identifier and the file name of the media object. The user of the target device 20 can click on the link and connect with the media server 36. The media server 36 can be configured to determine that the link includes the identifier for device 14 and a file path. The media server 36 can locate device 14 and request the media object. When the media object is uploaded to the media server 36 the media server can download it to the target device.

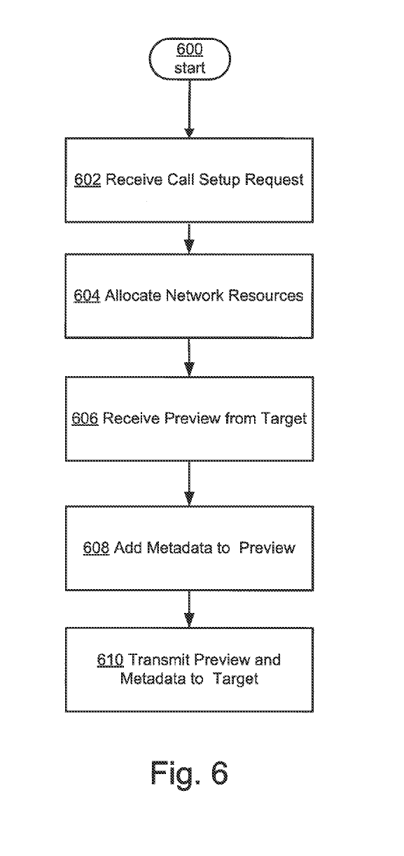

Referring now to FIG. 6, which illustrates example operational procedures related to sending previews to target mobile devices 20. For example, a service provider system that can include a media server 36 and a dispatch call handler (DCH) that can facilitate the transfer of media objects from a source to a target. For example, operation 600 begins the operational procedure and operation 602 illustrates that the DCH can receive a call set up request message indicating that a user of device 14 wants to establish a push-to-talk session. Operation 604 illustrates that network resources can be allocated to handle the request. In one example embodiment the DCH can be configured to determine that the target is allowed to receive the preview by querying either the media client 110 of target device 20 or a database of information that identifies the capabilities of the target device 20. In the same, or other embodiments, the DCH can be configured to include circuitry for looking up the address in a database of accounts and determine whether the target 20 is eligible to receive previews and/or receive media objects over the PTT link. For example in an embodiment the target 20 may not have paid a monthly fee associated with receiving media objects over a PTT link. If, for example, the target 20 is not eligible, e.g., the user has not subscribed to a service that supports media objects, or the device 20 is not capable of receiving such media objects, a signal can be sent to a SMS server and a text message can be generated and sent to the target 20 indicating that they can not receive the preview for the media object.

Continuing with the description of FIG. 6, operation 606 illustrates that the DCH can receive a preview from the source device 14 and forward it to the target device 20. In this example data over the PTT channel can be routed through the DCH and a computer system of the DCH can include circuitry to parse the preview; and add metadata to the preview as shown by operation 608. For example, metadata can be added to the preview such as information about the location of the media object on the media server 36 and or information according to business rules established by the service provider. For example, a business rule could exist indicating that all media objects downloaded on a certain date are free. In this example if the date matches the date in the business rule than information can be added to the preview indicating that the download for the media object would be free. In another example, an advertisement can be added to the preview, e.g., in the body of a message that includes the preview, or it can be sent in a separate package prior to the preview. In this example, the circuitry of the target 20 can be configured to display the advertisement before allowing the user to access the preview. In this example the user of the target 20 may not pay to receive media objects but may have agreed to get free media objects for watching advertisements. Continuing with the description, and as illustrated by operation 610, once metadata is added to the preview it can be transmitted to the target via a base transceiver station.

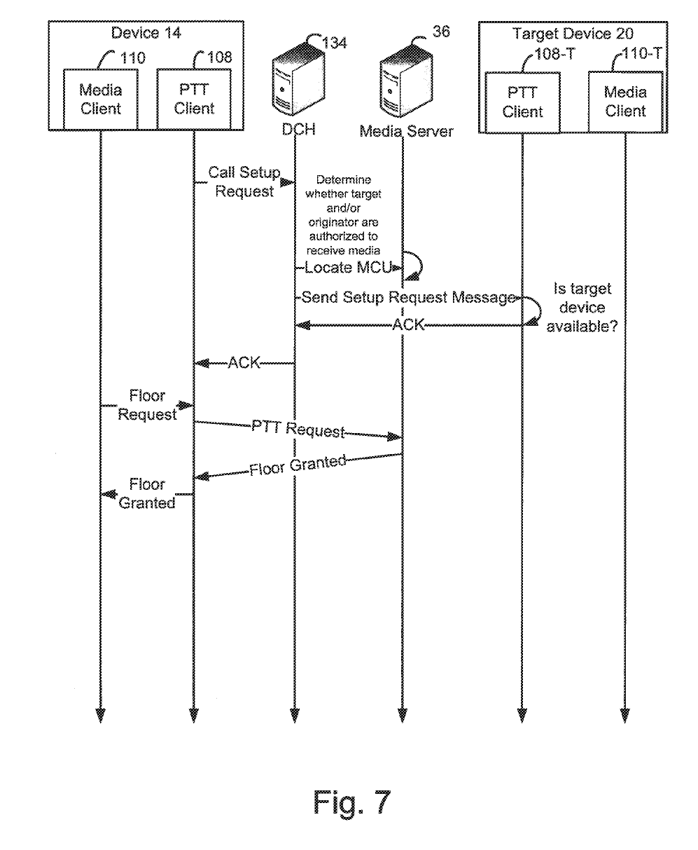

Referring now to FIG. 7, there is illustrated an example call flow diagram for establishing a push-to-talk session. For example, the user of the device 14 may determine that they want to engage in a PTT conversation with a user of a target device 20 and request a push-to-talk session. A PTT session can be established by the PTT client 108 by selecting a contact from an address book and pressing the PTT button 78 of FIG. 3. In one embodiment the PTT client 108 can receive an indication of the selection and send a call setup request message to a DCH 134. The call setup request can contain, for instance, the target device's address, and an indication that media objects are to be shared, and information that identifies the media server 36 that stores media for the mobile device 14. The call setup request may also be sent with a DataOverSignaling Access channel message. In an example embodiment, the DCH 134 can be configured to perform the PTT call setup functions, including locating the target, applying call restrictions, selecting a vocoder and location and/or assign a media server 36 to handle storing any media objects uploaded during the PTT session. The media server 36 can then be notified that a media PTT session is being created and the identities of both the originator device and the target device. In this example the DCH 134 can include circuitry operable to determine whether mobile device 14 is allow to send/receive media objects and/or whether the target device 20 is authorized to send/receive media objects. If for example, both devices are allowed to send/receive media objects and the target is available for a PTT session the DCH 134 can send an acknowledgment message to the originating mobile device 14 and the originating mobile device 14 can obtain the floor.

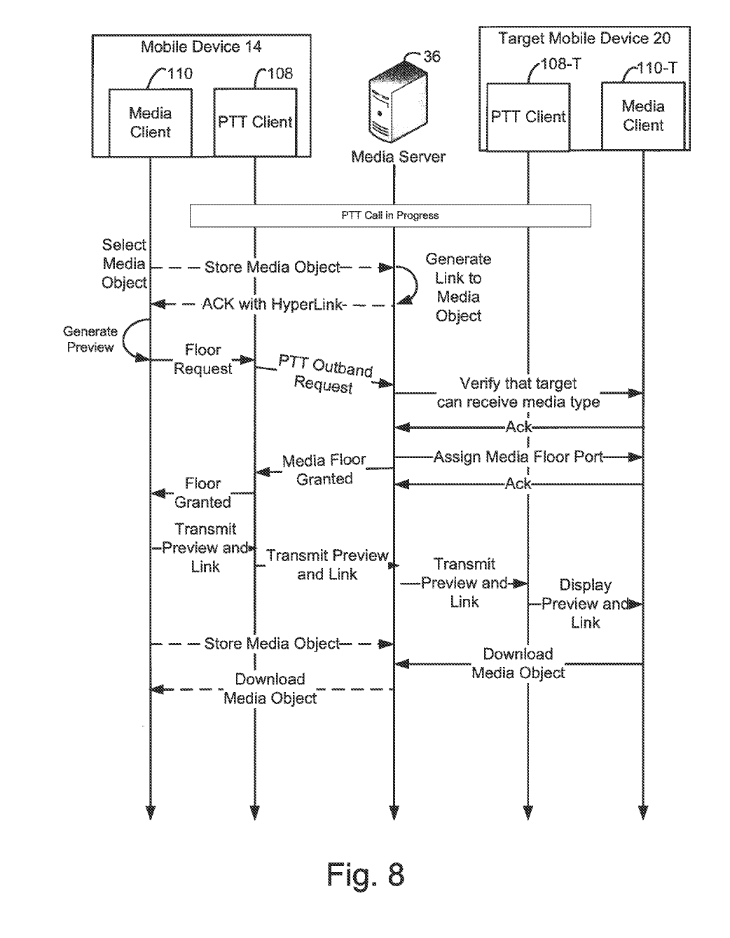

Referring now to FIG. 8, it illustrates an example call flow diagram for transmitting a preview for a media object during a floor that is shared between talking and sending previews for media objects. As is illustrated by FIG. 8, in an embodiment of the present disclosure the PTT session can be established and the media object could be uploaded to the media server 36. In this example flow diagram however the media object could be stored by the media server 36 after the call was started or after the call has ended. For example, during the conversation the originator may take a picture of something, or think of a media object stored on the device 14 that is relevant to the discussion and want to share it. In an example embodiment the media object can then be uploaded via a data channel to the media server 36 and the media server 36 can generate a hyperlink to the media object.

Continuing with the description of FIG. 8, the user of the originating device 14 can then request to send a preview of a media object with a PTT call using the same floor mechanism as the PTT call. That is, the preview for the media object in this example can be sent in conjunction with voice during the PTT talk spurt. In this example embodiment the media client 110 can request permission to talk and can send data at the same time. In this scenario the user can be participating in a PTT call and the user can perform a function to the media client 110 to share data during subsequent talk burst from the user. That is, in this example there is only a single floor control mechanism that is used for both the PTT call and the sharing of previews of media. The media client 110 can in this example request that the PTT client 108 to add a preview for a media object to the existing PTT call. The add-media request can contain an indication that the data is to be shared using the same floor control mechanism as the PTT Client 110. The PTT Client 110 can in this example request that the media server 36 add a new media type to the existing call. The media server 36 can verify that the target mobile device 20 can support the new media type, e.g. by contacting media client 110-T, and notify mobile device 14 that a new media type is being added to the PTT call. After the new media type has been successfully added to the PTT call, the user can request permission to talk and send a preview for the media object at the same time.

In an example embodiment the media client 110 can transmit a preview to the target device 20 over the push-to-talk channel. In this example the media server 36 can be configured to receive the preview; add additional metadata to the preview; and transmit the preview to the target device. For example, in an embodiment of the present disclosure the device 14 may not upload the media object to the media server until after the preview was generated and sent to the target. In this example when the media server 36 receives the preview it can store information that identifies the media object that preview is associated with and a device identifier for the originating device 14. The media server 36 can then request a copy of the media object for storage from the originating device 14 and upload the media object over a data channel. In an alternative embodiment the user of the originating device 14 can upload a copy of the media object after or during the PTT over the data channel.

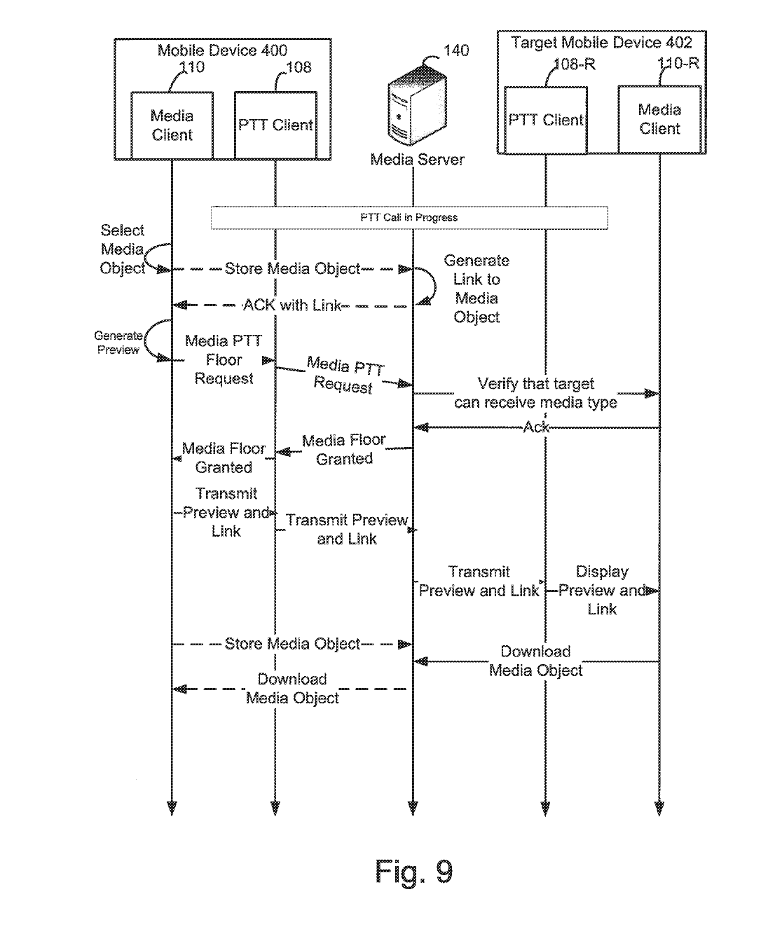

Referring now to FIG. 9, it illustrates an example call flow diagram for transmitting a preview for a media object on a different floor from the PTT client of the target mobile device 402. In this example embodiment the media client 110 can be configured to request to transmit a preview to the target 20 using a different floor control mechanism than the PTT call. In this example the preview for the media object is send independently from the voice data over a media PTT channel. For example, in an embodiment the user can request permission to send data at any time there is data that is ready to be shared with the target mobile device 20. In this scenario, the user of mobile device 14 can participate in a PTT call and perform a function on the media client 110 directing the media client 110 to share a preview with the target mobile device 20. In this example the media client 110 can be configured to determine that the data is intended to be shared using a separate floor control mechanism than the PTT call, i.e. independent of the floor control mechanism being used for the PTT call and send a request to the PTT client 108 to add a new media type to the existing PTT call. The add media requests can contain an indication that the data is to be shared using a different floor control mechanism than the PTT call. The PTT Client 108 can in this example send a request to the media server 36 to add a new media type to the existing call. The media server 36 can be configured to verify that one or more of the call participants can support the new media type and then the media server 140 can send a notification to the call participants indicating that a new media type is being added to the call. In this embodiment, the notification to the call participants can contain a floor identifier for a separate media floor, in addition to a new destination port number on the media server 36 for the distribution of the preview for the media object. The PTT Client 108-R of the target device 20 can assign a new media port for sending or receiving group-directed media and sends the new port identifier in the acknowledgement to the media server 36 and ultimately receive the media at Media Client 110-R.

After the new media type is successfully added to the PTT call, the user can request permission to send a preview for the media object. The media client 110 can be configured to notify the PTT client 108 that a group-directed media send request has been received. The PTT client 108 can be configured to request permission to send group directed media from the media server 36. The PTT request from the PTT client 108 can contain the floor identifier assigned to the group-directed media floor. The media server 36 can verify that the data floor is available prior to granting the floor request. The PTT client 108 can then notify the media client 110 that the floor request was granted.

In one embodiment, an apparatus or method may perform operations for a wireless communication device to send previews for a media object over a communication link. A processor of the wireless communication device may perform the operations of receiving a selection of a media object for transmission, transmitting the media object to a media server in a format enabling the media server to distribute the media object to a target device, selecting a plurality of previews in accordance with a user selection, wherein the previews comprise items selected from a group consisting of generated objects derived from the media object and independent objects not derived from the media object, and transmitting one of the plurality of previews and a link to download the media object from the media server to each of a plurality of target devices over a group communication channel. In this manner, a target device may download a media object over another communication link so as to preserve resources used by the group communication channel.

In various embodiments, additional operations may be performed. In an embodiment, the processor of the wireless communication device may further perform the operations of receiving user defined metadata for the media object or transmitting metadata for the media object to the media server. In another embodiment, the processor of the wireless communication device may further perform the operations of selecting a first preview in accordance with a user selection for a first target device, selecting a second preview in accordance with a user selection for a second target device, and transmitting the first preview to the first target device and the second preview to the second target device over the group communication channel. Optionally, selecting the first preview in accordance with the user selection for the first target device may include selecting a preview comprising an independent object not derived from the media object selected from the group consisting of emoticons, generic images, trademarked images, audio files, and movie files. Selecting the second preview in accordance with the user selection for the second target device may also include generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

In another embodiment, selecting a plurality of previews in accordance with a user selection may further include the operation of selecting a preview that is an independent object not derived from the media object. These previews may include emoticons, generic images, trademarked images, audio files, and movie files. Optionally, selecting a plurality of previews in accordance with a user selection may further include generating a preview where the preview may be an object derived from the media object selected from the group consisting of compressed forms of the media object, reduced size forms of the media object, clipped forms of the media object, cropped forms of the media object, converted forms of the media object, downsampled forms of the media object, and modified forms of the media object. Generating the preview for the media object may further comprise calculating file size of the preview, and displaying the file size of the preview on a display of the device, as well as optionally displaying information that identifies a maximum transmission unit for the preview.

Other embodiments may include a processor of the wireless communication device which may further perform the operations of: receiving, from the media server, metadata for the media object, and transmitting the metadata to each of the target devices over the group communication channel; transmitting information that identifies a user account to which a cost associated with downloading the media object is to be charged when each of the target devices download the media object from the media server; or receiving, from the media server, information that identifies file format conversion options for the media object, and transmitting the information that identifies the file format conversion options to each of the target devices.

In further embodiments in which the group communication channel includes a floor thereof, transmitting the plurality of previews can be configured to occur only upon having the floor, or alternately, occur irrespective of the device having the floor.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

In view of the methods being executable on a mobile device and other computer platforms, the method can accordingly be performed by a program resident in a computer readable medium, where the program directs the mobile device or other computer device having a computer platform to perform the steps of the method. The computer readable medium can be the memory of a server, or can be in a connective database. Further, the computer readable medium can be in a secondary storage media that is loadable onto a communication device computer platform, such as a magnetic disk or tape, optical disk, hard disk, flash memory, or other storage media as is known in the art.

In one or more exemplary embodiments, the functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where “disks” usually reproduce data magnetically, while “discs” reproduce data optically with lasers. Combinations of the above should also be included within the scope of computer-readable media.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A wireless communication device configured to send previews for a media object over a communication link, the wireless communication device comprising:
a memory;
a processor coupled to the memory, wherein the processor is configured with processor-executable instructions to perform operations comprising:
receiving a selection of a media object for transmission;
transmitting the media object to a media server in a format enabling the media server to distribute the media object to a target device;
selecting a plurality of previews in accordance with a user selection, wherein the previews comprise items selected from a group consisting of generated objects derived from the media object and independent objects not derived from the media object; and
transmitting one of the plurality of previews and a link to download the media object from the media server to each of a plurality of target devices over a group communication channel.

2. The wireless communication device of claim 1, wherein the processor is configured with processor-executable instructions to perform operations further comprising:
receiving user defined metadata for the media object.

3. The wireless communication device of claim 1, wherein the processor is configured with processor-executable instructions such that selecting the plurality of previews for the media object further comprises:
selecting a first preview in accordance with a user selection for a first target device;
selecting a second preview in accordance with a user selection for a second target device; and
transmitting the first preview to the first target device and the second preview to the second target device over the group communication channel.

4. The wireless communication device of claim 3, wherein the processor is configured with processor-executable instructions to perform operations such that selecting the first preview in accordance with the user selection for the first target device further comprises:
selecting a preview comprising an independent object not derived from the media object selected from the group consisting of emoticons, generic images, trademarked images, audio files, and movie files.

5. The wireless communication device of claim 4, wherein the processor is configured with processor-executable instructions to perform operations such that selecting the second preview in accordance with the user selection for the second target device further comprises:
generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

6. The wireless communication device of claim 1, wherein the processor is configured with processor-executable instructions such that selecting a plurality of previews in accordance with a user selection further comprises:
selecting a preview comprising an independent object not derived from the media object selected from the group consisting of emoticons, generic images, trademarked images, audio files, and movie files.

7. The wireless communication device of claim 6, wherein the processor is configured with processor-executable instructions such that selecting a plurality of previews in accordance with a user selection further comprises:
generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

8. The wireless communication device of claim 7, wherein the processor is configured with processor-executable instructions such that generating the preview for the media object further comprises:
calculating file size of the preview; and
displaying the file size of the preview on a display of the wireless communication device.

9. The wireless communication device of claim 8, wherein the processor is configured with processor-executable instructions to perform operations further comprising:
displaying information that identifies a maximum transmission unit for the preview.

10. The wireless communication device of claim 1, wherein the processor is configured with processor-executable instructions to perform operations further comprising:
transmitting metadata for the media object to the media server.

11. The wireless communication device of claim 1, wherein the processor is configured with processor-executable instructions to perform operations further comprising:
receiving, from the media server, metadata for the media object; and
transmitting the metadata to each of the target devices over the group communication channel.

12. The wireless communication device of claim 1, wherein the processor is configured with processor-executable instructions to perform operations further comprising:
transmitting information that identifies a user account to which a cost associated with downloading the media object is to be charged when each of the target devices download the media object from the media server.

13. The wireless communication device of claim 1, wherein the processor is configured with processor-executable instructions to perform operations further comprising:
receiving, from the media server, information that identifies file format conversion options for the media object; and
transmitting the information that identifies the file format conversion options to each of the target devices.

14. The wireless communication device of claim 1, wherein the group communication channel includes a floor thereof, and wherein the processor is configured with processor-executable instructions such that transmitting the plurality of previews only occurs upon having the floor.

15. The wireless communication device of claim 1, wherein the group communication channel includes a floor thereof, and wherein the processor is configured with processor-executable instructions such that transmitting the plurality of previews occurs irrespective of the device having the floor.

16. A wireless communication device configured to send previews for a media object over a communication link, the wireless communication device comprising:
means for receiving a selection of a media object for transmission;
means for transmitting the media object to a media server in a format enabling the media server to distribute the media object to a target device;
means for selecting a plurality of previews in accordance with a user selection, wherein the previews comprise items selected from a group consisting of generated objects derived from the media object and independent objects not derived from the media object; and
means for transmitting one of the plurality of previews and a link to download the media object from the media server to each of a plurality of target devices over a group communication channel.

17. The wireless communication device of claim 16, further comprising:
means for receiving user defined metadata for the media object.

18. The wireless communication device of claim 16, wherein means for selecting the plurality of previews for the media object further comprises:
means for selecting a first preview in accordance with a user selection for a first target device;
means for selecting a second preview in accordance with a user selection for a second target device; and
means for transmitting the first preview to the first target device and the second preview to the second target device over the group communication channel.

19. The wireless communication device of claim 18, wherein means for selecting the first preview in accordance with the user selection for the first target device further comprises:
means for selecting a preview comprising an independent object not derived from the media object selected from the group consisting of emoticons, generic images, trademarked images, audio files, and movie files.

20. The wireless communication device of claim 19, wherein means for selecting the second preview in accordance with the user selection for the second target device further comprises:
means for generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

21. The wireless communication device of claim 16, wherein means for selecting a plurality of previews in accordance with a user selection further comprises:
means for selecting a preview comprising an independent object not derived from the media object selected from the group consisting of emoticons, generic images, trademarked images, audio files, and movie files.

22. The wireless communication device of claim 21, wherein means for selecting a plurality of previews in accordance with a user selection further comprises:
means for generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

23. The wireless communication device of claim 22, wherein means for generating the preview for the media object further comprises:
means for calculating file size of the preview; and
means for displaying the file size of the preview on a display of the wireless communication device.

24. The wireless communication device of claim 23, further comprising:
means for displaying information that identifies a maximum transmission unit for the preview.

25. The wireless communication device of claim 16, further comprising:
means for transmitting metadata for the media object to the media server.

26. The wireless communication device of claim 16, further comprising:
means for receiving, from the media server, metadata for the media object; and
means for transmitting the metadata to each of the target devices over the group communication channel.

27. The wireless communication device of claim 16, further comprising:
means for transmitting information that identifies a user account to which a cost associated with downloading the media object is to be charged when each of the target devices download the media object from the media server.

28. The wireless communication device of claim 16, further comprising:
means for receiving, from the media server, information that identifies file format conversion options for the media object; and
means for transmitting the information that identifies the file format conversion options to each of the target devices.

29. The wireless communication device of claim 16, wherein the group communication channel includes a floor thereof, and wherein means for transmitting the plurality of previews only sends the previews upon having the floor.

30. The wireless communication device of claim 16, wherein the group communication channel includes a floor thereof, and wherein means for transmitting the plurality of previews sends the previews irrespective of the device having the floor.

31. A method performed on a wireless communication device for sending previews for a media object to a plurality of target devices over a group communication channel, the method comprising:
receiving a selection of the media object for transmission;
transmitting the media object to a media server in a format enabling the media server to distribute the media object to a target device;
selecting a plurality of previews in accordance with a user selection, wherein the previews comprise items selected from a group consisting of generated objects derived from the media object and independent objects not derived from the media object; and
transmitting one of the plurality of previews and a link to download the media object from the media server to each of the plurality of target devices over the group communication channel.

32. The method of claim 31, further comprising:
receiving user defined metadata for the media object.

33. The method of claim 31, wherein selecting the plurality of previews for the media object further comprises:
selecting a first preview in accordance with a user selection for a first target device;
selecting a second preview in accordance with a user selection for a second target device; and
transmitting the first preview to the first target device and the second preview to the second target device over the group communication channel.

34. The method of claim 33, wherein selecting the first preview in accordance with the user selection for the first target device further comprises:
selecting a preview comprising an independent object not derived from the media object selected from the group consisting of emoticons, generic images, trademarked images, audio files, and movie files.

35. The method of claim 34, wherein selecting the second preview in accordance with the user selection for the second target device further comprises:
generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

36. The method of claim 31, wherein selecting a plurality of previews in accordance with a user selection further comprises:
selecting a preview comprising an independent object not derived from the media object selected from the group consisting of emoticons, generic images, trademarked images, audio files, and movie files.

37. The method of claim 36, wherein selecting a plurality of previews in accordance with a user selection further comprises:
generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

38. The method of claim 37, wherein generating the preview for the media object further comprises:
calculating file size of the preview; and
displaying the file size of the preview on a display of the wireless communication device.

39. The method of claim 38, further comprising:
displaying information that identifies a maximum transmission unit for the preview.

40. The method of claim 31, further comprising:
transmitting metadata for the media object to the media server.

41. The method of claim 31, further comprising:
receiving, from the media server, metadata for the media object; and
transmitting the metadata to each of the target devices over the group communication channel.

42. The method of claim 31, further comprising:
transmitting information that identifies a user account to which a cost associated with downloading the media object is to be charged when each of the target devices download the media object from the media server.

43. The method of claim 31, further comprising:
receiving, from the media server, information that identifies file format conversion options for the media object; and
transmitting the information that identifies the file format conversion options to each of the target devices.

44. The method of claim 31, wherein transmitting the plurality of previews only occurs upon having the floor.

45. The method of claim 31, wherein transmitting the plurality of previews occurs irrespective of the device having the floor.

46. A non-transitory computer-readable medium having stored thereon processor-executable instructions configured to cause a processor of a wireless communication device to perform operations comprising:
receiving a selection of a media object for transmission;
transmitting the media object to a media server in a format enabling the media server to distribute the media object to a target device;
selecting a plurality of previews in accordance with a user selection, wherein the previews comprise items selected from a group consisting of generated objects derived from the media object and independent objects not derived from the media object; and
transmitting one of the plurality of previews and a link to download the media object from the media server to each of a plurality of target devices over a group communication channel.

47. The non-transitory computer-readable medium of claim 46, wherein the processor-executable instructions are configured to cause a processor of a wireless communication device to perform operations further comprising:
receiving user defined metadata for the media object.

48. The non-transitory computer-readable medium of claim 46, wherein the processor-executable instructions are configured to cause a processor of a wireless communication device to perform operations such that selecting the plurality of previews for the media object further comprises:
selecting a first preview in accordance with a user selection for a first target device;
selecting a second preview in accordance with a user selection for a second target device; and
transmitting the first preview to the first target device and the second preview to the second target device over the group communication channel.

49. The non-transitory computer-readable medium of claim 48, wherein the processor-executable instructions are configured to cause a processor of a wireless communication device to perform operations such that selecting the first preview in accordance with the user selection for the first target device further comprises:
selecting a preview comprising an independent object not derived from the media object selected from the group consisting of emoticons, generic images, trademarked images, audio files, and movie files.

50. The non-transitory computer-readable medium of claim 49, wherein the processor-executable instructions are configured to cause a processor of a wireless communication device to perform operations such that selecting the second preview in accordance with the user selection for the second target device further comprises:
generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

51. The non-transitory computer-readable medium of claim 46, wherein the processor-executable instructions are configured to cause a processor of a wireless communication device to perform operations such that selecting a plurality of previews in accordance with a user selection further comprises:
selecting a preview comprising an independent object not derived from the media object selected from the group consisting of emoticons, generic images, trademarked images, audio files, and movie files.

52. The non-transitory computer-readable medium of claim 51, wherein the processor-executable instructions are configured to cause a processor of a wireless communication device to perform operations such that selecting a plurality of previews in accordance with a user selection further comprises:
generating a preview comprising an object derived from the media object selected from the group consisting of compressed forms of the media object, reduced size forms of the media object, clipped forms of the media object, cropped forms of the media object, converted forms of the media object, downsampled forms of the media object, and modified forms of the media object.

53. The non-transitory computer-readable medium of claim 52, wherein the processor-executable instructions are configured to cause a processor of a wireless communication device to perform operations such that generating the preview for the media object further comprises:
calculating file size of the preview; and
displaying the file size of the preview on a display of the wireless communication device.

54. The non-transitory computer-readable medium of claim 53, wherein the processor-executable instructions are configured to cause a processor of a wireless communication device to perform operations further comprising:
displaying information that identifies a maximum transmission unit for the preview.

55. The non-transitory computer-readable medium of claim 46, wherein the processor-executable instructions are configured to cause a processor of a wireless communication device to perform operations further comprising:
transmitting metadata for the media object to the media server.

56. The non-transitory computer-readable medium of claim 46, wherein the processor-executable instructions are configured to cause a processor of a wireless communication device to perform operations further comprising:
receiving, from the media server, metadata for the media object; and
transmitting the metadata to each of the target devices over the group communication channel.

57. The non-transitory computer-readable medium of claim 46, wherein the processor-executable instructions are configured to cause a processor of a wireless communication device to perform operations further comprising:
transmitting information that identifies a user account to which a cost associated with downloading the media object is to be charged when each of the target devices download the media object from the media server.

58. The non-transitory computer-readable medium of claim 46, wherein the processor-executable instructions are configured to cause a processor of a wireless communication device to perform operations further comprising:
receiving, from the media server, information that identifies file format conversion options for the media object; and
transmitting the information that identifies the file format conversion options to each of the target devices.

59. The non-transitory computer-readable medium of claim 46, wherein the group communication channel includes a floor thereof, and wherein the processor-executable instructions are configured to cause a processor of a wireless communication device to perform operations such that transmitting the plurality of previews only occurs upon having the floor.

60. The non-transitory computer-readable medium of claim 46, wherein the group communication channel includes a floor thereof, and wherein the processor-executable instructions are configured to cause a processor of a wireless communication device to perform operations such that transmitting the plurality of previews occurs irrespective of the device having the floor.
